(19) United States
(12) Patent Application Publication
(10) Pub. No.: US 2004/0129460 A1
(43) Pub. Date: Jul. 8, 2004

(54) Method for using coconut coir as a lost circulation material for well drilling

(76) Inventors: Malcolm MacQuoid, (US); David Skodack, The Woodlands, TX (US)

Correspondence Address: RANDALL B. BATEMAN, BATEMAN IP LAW GROUP, 4 TRIAD CENTER, SUITE 825, PO BOX 1319, SALT LAKE CITY, UT, 84110, US

(21) Appl. No.: 10/626,503

(22) Filed: Jul. 23, 2003

Related U.S. Application Data
(60) Provisional application No. 60/400,477, filed on Aug. 1, 2002.

(51) Int. Cl. C09K 7/00

(52) U.S. Cl. 175/72

(57) ABSTRACT

A method for preventing loss of drilling fluid into fractures in the rock formation being drilled includes using coconut coir as a lost circulation material. Additionally, an effective mixture for reducing drilling fluid loss includes drilling fluid and coconut coir. Other lost circulation materials can also be added.

1. Related Applications

The present application claims the benefit of U.S. Provisional Application No. 60/400,477, filed Aug. 1, 2002.

### BACKGROUND OF THE INVENTION

2. Field of the Invention

The present invention relates to a method for using coconut coir as a lost circulation material to either prevent or mitigate loss of drilling fluid when drilling wells. More particularly, the present invention relates to adding coconut coir to drilling fluid or to a mixture of conventional lost circulation materials and drilling fluid in order to prevent or mitigate loss of drilling fluid that otherwise occurs during the process of well drilling.

3. State of the Art

Drilling has long been the standard method for accessing underground deposits of liquids and gases such as water, oil, and natural gas. Because most types of drilling require either rotational or reciprocal movement of the drilling apparatus within the borehole, reducing friction and dissipating the heat produce by such friction is an important component of any drilling operation. Friction reduction is generally accomplished through the use of a fluid such as water or oil. Pursuant to standard practice, the fluid is inserted into the borehole, where it acts as a lubricant at the point where the drilling pipe contacts the well surface. The lubricating fluid acts to both reduce friction and also to carry away heat that is produced by the rotational or reciprocal movement of the drilling apparatus.

Because of the need to maintain lubricating fluid in the bore hole, one of the challenges of drilling is to keep the lubricant from seeping out of the hole. The loss of drilling fluid is a pervasive and expensive problem facing the well drilling industry. Whenever the hydrostatic pressure of the fluid column exceeds the pressure that exists within openings in the rock formation, drilling fluid will be forced into the openings, resulting in loss of drilling fluid. Loss of drilling fluid typically occurs when very permeable or fractured rock formations are encountered. Some of the typical rock formations causing lost drilling fluid include; induced fractures, natural open fractures, porous rock formations, or cavernous openings (like small cavities in limestone formations called “vugs”) that exist in the rock formation being penetrated by the drilling operation.

Induced fractures are typically caused by large increases or spikes in the well pressure while drilling. While induced fracturing of the surrounding rock usually can be avoided by careful drilling, some induced fracturing may still occur. Additionally, naturally occurring fractures, fissures, faults, or caverns in the rock are encountered during drilling. These rock formations provide areas of high permeability that allow drilling fluid to easily seep into the rock. Such rock formations may cause sudden loss of all or a significant part of the drilling fluid. Sudden losses of drilling fluid and corresponding losses in well pressure may cause the rock formation to become unstable, and may cause a blowout, resulting in damage to the well and equipment and injury to the workers. Even if such damage does not occur, the loss of significant amounts of drilling fluid greatly increases the cost of drilling.

To inhibit this loss, the drilling fluid must contain some type of constituent that will block the open holes in the rock. Drilling fluids will typically include constituents that act as a bridging agent across the openings in the rock formation; physically sealing them as the agent lodges into the hole and prevents more drilling fluid from seeping in. These agents are typically referred to as lost circulation materials.

The drilling industry has studied numerous lost circulation materials (LCM) and has vast field experience using currently available products. A considerable variety of materials have been used at one time or another as LCM. They are generally divided into four categories; fibrous materials, flaky materials, granular materials, and slurries.

Fibrous materials include such things as cotton fibers, cottonseed hulls, rice hulls, shredded automobile tires, wood fibers, sawdust, and paper pulp. These materials have little rigidity and inhibit lost circulation by being forced into openings and bridging them off which allows the drilling fluid filtration control agents to become more effective. Flaky materials include such things as mica, shredded cellophane, wood chips, and plastic laminate. These materials inhibit lost circulation by laying flat across the face of the leaking formation, thereby sealing it off.

Granular materials include items such as ground nutshells, perlite, ground carbonate, sand and pea gravel. Because of their strength and rigidity, these materials seal by wedging themselves inside the openings of the leaking formation, reducing the size of the openings and allowing the drilling fluid filtration control agents to become effective. Slurries are mixtures whose strength generally increases after placement. These include hydraulic cement, oil-bentonite-mud mixes, and high filter loss drilling fluids. They are generally spotted across a zone of lost circulation and allowed to yield or set, thus sealing off the leaking formation.

Mixtures of the various categories of LCM have also proved beneficial. A blend of fibrous, flaky, and granular materials can be more effective than a single type on its own. A number of manufacturers have developed proprietary blends capitalizing on this principal.

One problem with conventional LCM is that they are not completely effective in closing the openings and preventing the loss of drilling fluid, or may be subsequently dislodged and allow further fluid loss. Another problem is that some of the more effective materials tend to be relatively expensive. Finally, conventional fibrous and flaky LCM also cause difficulties during mixing because their low density and small size give them a propensity to blow around when added through the mud hopper. This is a nuisance around the drilling rig and costly material is lost.

Thus, there is a need for an LCM that is low in cost and effective in preventing drilling fluid loss and that has a reduced propensity to blow around and be lost when added through the mud hopper. The present invention addresses these problems in that it employs a relatively inexpensive and effective LCM material, namely coconut coir.

### SUMMARY OF THE INVENTION

It is an object of one aspect of the present invention to provide a new LCM that is generally inexpensive and relatively easy to use.

It is another object of one aspect of the present invention to provide such an LCM that is effective in mitigating loss of drilling fluid.

Thus, the present invention involves using coconut coir as the lost circulation material (LCM), or as a component of the LCM. Coconut coir is a tough, natural material derived from coconut husks. When coconut husks are processed, long and short fibers and granular powder is produced. The long fibers are cleaned and compressed into bales and have historically been used as raw material for mats, car seat filler, furniture pads, geotextiles, erosion control, rope, packaging, etc. Some fiber is also used for agricultural purposes for its soil beneficiation properties. Those properties include increased moisture retention, aeration, pH control in acid soils, and as a source of organic matter.

After the longer fibers are processed, the relatively short fibers and granular or powdered portion remain. This is traditionally discarded as a waste by-product of the processing of the coconuts. The tremendous volume of coconut coir that is produced as a by-product of coconut processing has always presented a disposal problem to coconut processors. The coconut coir is generally left in large piles near the location where the coconuts are processed. Piles of discarded coconut coir can present health, fire and bio-hazards. In addition, they are a fertile habitat and breeding ground for species of beetles which are harmful to coconut trees.

The present invention involves mixing coconut coir with water and/or other drilling fluid for use as an LCM. Coconut coir has properties that are beneficial as an additive for use in lost circulation purposes. Processed coir that has had the long fibers removed for other purposes still retains shorter fibers that are tough mechanically but pliable enough to pass through a drill bit nozzle. Processed coir also retains coconut husk fines that resemble small flakes as well as dust-like particles from the shell of coconut that are granular in nature. It is the mix of various particle shapes and sizes that when added to drilling fluid act like a blend of more conventional LCM materials. Coir also has the unique property that the surfaces of the fibers, flakes, and particles have a natural affinity for oil. In fact, these properties make coir a very effective oil spill absorbent. This property also allows the material to be effective in oil-based drilling fluids as well as water-based fluids. It is more easily distributed in the oil phase of the oil-based drilling fluid.

Coconut coir, when mixed with the drilling fluid, is effective as an LCM. It is also effective when used in combination with other more conventional LCM, and can increase the effectiveness of a drilling fluid containing other LCM.

The exact amount of coconut coir used is highly dependent on the situation in which it is being used and the other materials with which it is mixed. For example, when the coconut coir is mixed with water the amount of coir used will typically be between 5 and 50 lbs. per barrel (42 gallons). This is roughly between about 1.4 and 14 percent by weight. However, smaller or greater amounts of coir, such as 2 to 75 lbs. or even 1 to 100 lbs. per barrel could be used in certain situations. The exact amount which will be used depends on the nature of the soil and the other additives used in the water. Where the coconut coir is combined with other types of lost circulation materials in addition to water, the amount of coir used will typically be less than is used when the coir is mixed with water alone.

Similarly, the amount of coir used will vary depending upon the type of soil and rock formation being drilled. A greater quantity of coconut coir would typically be needed for a given quantity of water where the soil and rock formation contains a larger than average number of fractures and openings, or where the fractures and openings are larger than average.

In order to prevent the coir from being blown around when added through the mud hopper, the present invention also involves using coconut coir that has been formed into a “pellet” that binds the fibers, flakes, and particles together so that they enter the mud hopper as a larger and more dense pellet that is not easily blown away and lost. This development makes addition of the LCM easy, fast, and clean. Once the pellet enters the mud stream, the shear action and turbulence of the fluid steam passing though the hopper, the mud mixers, mud pumps, and mud jets effectively break up the pellets, releasing the coir.

Such pellets of coir may easily be manufactured by compressing the coir under pressure into round, cylindrical, or cubical shapes. One of skill in the art will appreciate that many other suitable methods exist for making pellets from a powdered material and this application is intended to cover such methods for making coir pellets. Similarly, a wide range of suitable shapes exist for the shape of the pellet.

While the use of pelletized coir comprises one embodiment of the present invention and i. a good means for preventing the coir from being blown around when added to the mud hopper, the use of pelletized coir is not an essential part of the invention. Coconut coir in various forms, including in its loose form can be used satisfactorily in this invention. However, when loose coir is used, the user must take into account the fact that the loose coir will tend to be blown around when added to the hopper and so some of the coir volume will be lost. In addition the different sized particles will tend to be lost at different rates with a greater percentage of flakes and the dust like particles being blown out and lost than the longer fibers. Thus, pelletized coir is advantageous in that the composition of the coir mixed into the mud and pumped into the well hole being drilled is easily controlled and a consistent composition of mud can be mixed.

When mixed with water, coir will absorb water, causing the coir particles to swell. This is advantageous as coir particles that lodge into the pores and holes of a region of drilling fluid loss can continue to absorb water and continue to swell. This will lodge the coir tighter into the hole and better seal the hole. This will better prevent loss of drilling fluid than common LCM materials. Accordingly, coir may be pressed or otherwise formed into small hard pellets that are sufficiently small and hard to pass the mud mixing and pumping equipment and pass into the well substantially intact.

When pellets, Bbs, etc. are formed under high pressure, the coir will require a longer time to fully absorb water and swell than individual fibers or particles. For example, a tightly compressed coir can taken up to several hours before it swells to its maximum size. Thus, by controlling the size and harness (i.e. extent of compression during formation) of the coir pellet, an operator can form a solution with desired loss stopping properties. Additionally, the coir can be mixed into water or mud once a substantial loss of drilling fluid is noticed. The coir will lodge into the hole through which loss is occurring, swell, and tightly seal the area of loss to prevent further loss of drilling fluid.

Once in the mud, the coconut coir based LCM is carried down the drill string, through the bit, and up the annulus between the drill string and the borehole where it is available to plug off zones of lost circulation. The physical plugging properties of the graded coir combined with the filtration loss control additives of the drilling fluid will effectively eliminate loss circulation problems in most situations.

### BRIEF DESCRIPTION OF THE DRAWINGS

The above and other objects, features and advantages of the invention will become apparent from a consideration of the following detailed description presented in connection with the accompanying drawings in which:

FIG. 1 shows a cross section of fractures in a typical rock formation surrounding the bore hole;

FIG. 2 shows the manner in which drilling fluid is lost through openings in the rock formation surrounding the well bore hole in the absence of LCM;

FIG. 3 shows the manner in which drilling fluid containing coconut coir as the LCM is forced in the openings in the rock formation that surround the bore hole; and

FIG. 4 shows the manner in which the coconut coir, when employed as an LCM, tends to lodge in the openings in the rock formation and thus blocks the further migration of drilling fluid into the openings.

### DETAILED DESCRIPTION

Reference will now be made to the drawings in which the various elements of the present invention will be given numeral designations and in. which the invention will be discussed so as to enable one skilled in the art to make and use the invention. It is to be understood that the following description is only exemplary of the principles of the present invention, and should not be viewed as narrowing the pending claims.

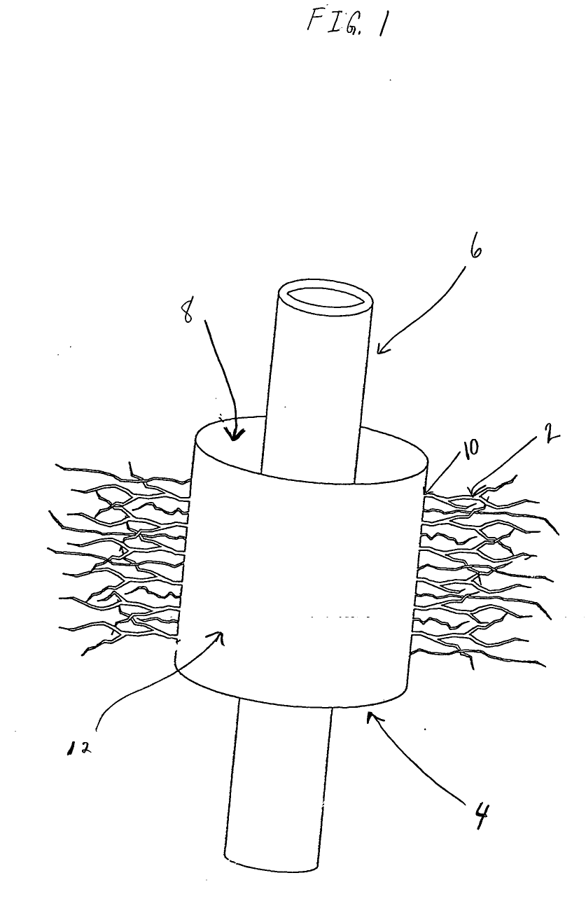

In FIG. 1 is shown a cross section of fractures 2 in a typical rock formation surrounding the bore hole 4. The drill pipe 6 extends through the well annulus 8. The rotational or reciprocal movement of the drill pipe 6, causes the drill pipe 6 to rub against the surface of the well annulus 8, producing friction, heat and wear on the well pipe 6. The fractures 2 in the rock formation create openings 10 in the well bore face 12 through which drilling fluid can flow. Larger fractures as well as numerous smaller fractures can cause excessive loss of drilling fluid.

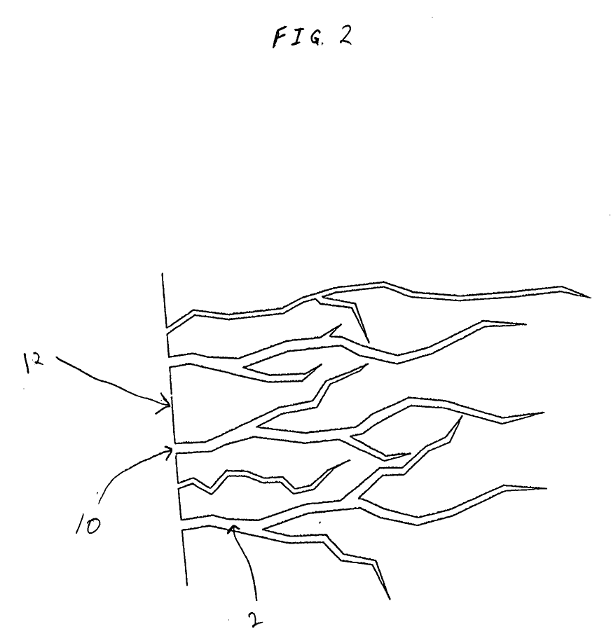

In FIG. 2 is shown a cross section of fractures 2 in the rock formation surrounding the well bore face 12 which create openings 10 in the well bore face 12. Drilling fluid flows out of the borehole through the openings 10. Depending on the size and number of the openings 10 and the characteristics of the soil/rock etc., a considerable amount, or even all of the drilling fluid can be lost.

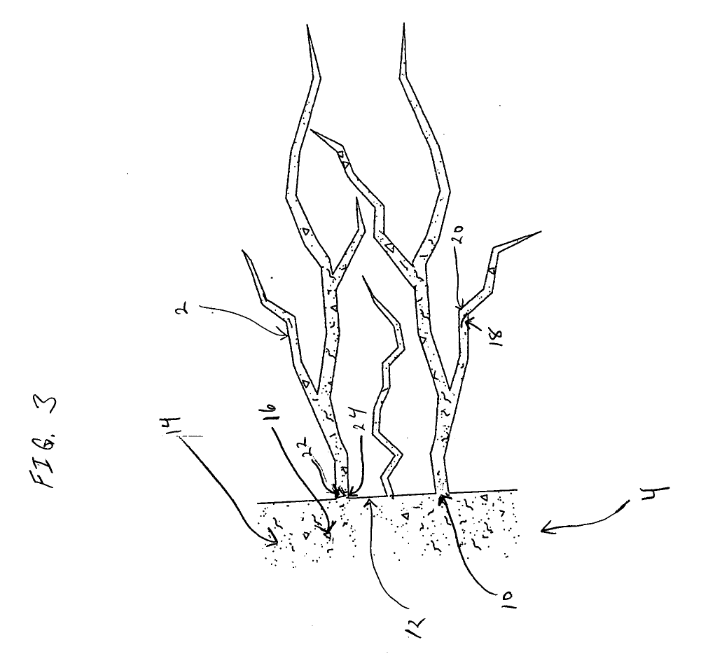

In FIG. 3 is shown a cross section of fractures 2 in the rock formation surrounding the well bore face 12. Drilling fluid containing coconut coir 16 has been inserted in the bore hole 4. The drilling fluid 14 containing the coconut coir 16 migrates through the openings 10 in the well bore face 12. As the coconut coir 16 migrates through the openings 10 in the well bore face 12, the smaller particles 18 tend to lodge across the smaller openings 20, while the larger particles 22 tend to lodge across the larger openings 24. As the coconut coir 16 continues to lodge in the fractures 2, it blocks the further migration of the drilling fluid 14 into the fractures 2. Thus, the coconut coir 16 eventually prevents further loss through the fractures 2. As particles of coir 16 continue to absorb water and swell they will more tightly seal the openings 20 and 24 in the rock and more completely block the flow of drilling fluid 14. Depending on the amount of compression used in forming a pellet, the coir may continue to swell for an hour or more.

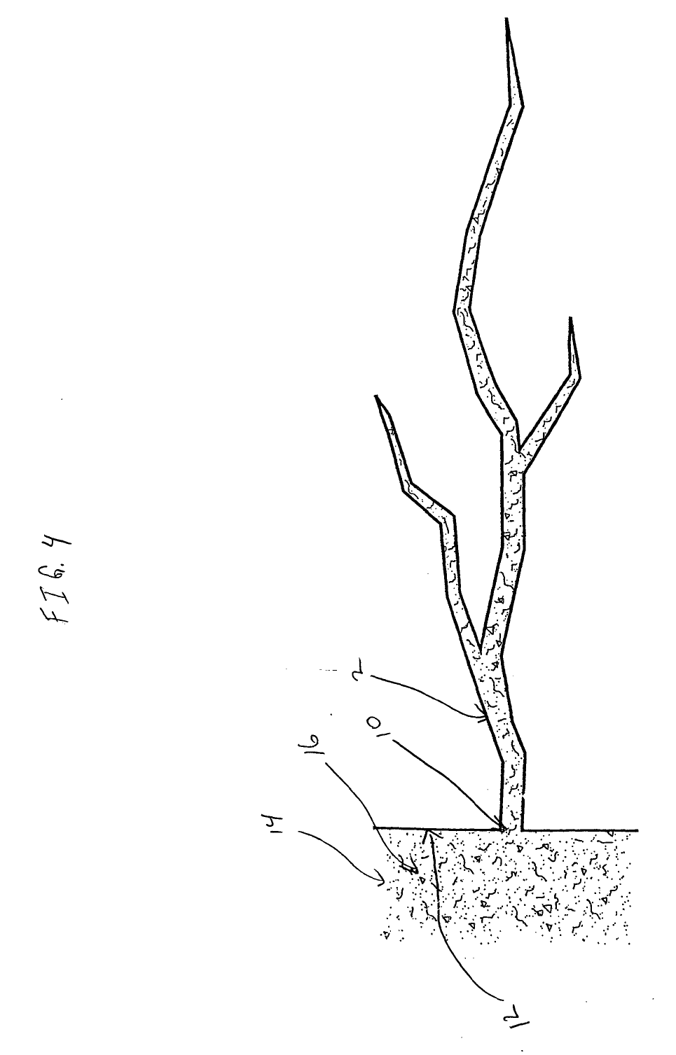

In FIG. 4 is shown a close-up view of a fracture 2, with the opening 10 through the well bore face 12. The drilling fluid 14 containing coconut coir 16 has migrated through the opening 10 and the coconut coir 16 has lodged in the fracture 2, impeding the further flow of drilling fluid.

As mentioned previously, the coir can be used as the only lost circulation medium, or can be used in combination with the materials discussed in the background section. By swelling to fill cracks in the rocks, etc., the coir helps improve the functioning of the other materials. Which materials may be used will depend in part on the types of rock and soil formations through which the drilling is being conducted. In light of the present disclosure, those skilled in the art will be able to formulate effective lost circulation mediums including coconut coir and one or more of the following: fibrous materials, flaky materials, granular materials, and slurries.

Without limitation, the coir can be mixed with fibrous materials including, but not limited to, such things as cotton fibers, cottonseed hulls, rice hulls, shredded automobile tires, wood fibers, sawdust, and paper pulp. Likewise, the coir can be mixed with flaky materials which include, but are not limited to, such things as mica, shredded cellophane, wood chips, and plastic laminate. Furthermore, the coir can be mixed with granular materials which include, but are not limited to, items such as ground nutshells, perlite, ground carbonate, sand and pea gravel. Finally, the coir can be mixed with slurries whose strength generally increases after placement, including, but not limited to, hydraulic cement, oil-bentonite-mud mixes, and high filter loss drilling fluids.

Thus, there is disclosed a new lost circulation medium or component thereof. Those skilled in the art will appreciate numerous modifications which can be made without departing from the scope and spirit of the invention. The appended claims are intended to cover such modifications.

What is claimed is:

1. A method for controlling loss of drilling fluid in a borehole comprising;
mixing coconut coir with the drilling fluid to form a drilling fluid mixture.

2. The method according to claim 1 wherein the drilling fluid mixture comprises of at least one type of lost circulation materials other than the coconut coir.

3. The method according to claim 2, wherein the at least one type of lost circulation material comprises a fibrous material.

4. The method according to claim 3, wherein the fibrous material comprises at least one of group consisting of as cotton fibers, cottonseed hulls, rice hulls, shredded automobile tires, wood fibers, sawdust, and paper pulp.

5. The method according to claim 2, wherein the at least one type of lost circulation material comprises a flaky material.

6. The method according to claim 5, wherein the flaky material comprises at least one of the group consisting of mica, shredded cellophane, wood chips, and plastic laminate.

7. The method according to claim 2, wherein the at least one type of lost circulation material comprises granular material.

8. The method according to claim 7, wherein the granular material comprises at least one of the group consisting of ground nutshells, perlite, ground carbonate, sand and pea gravel.

9. The method according to claim 2, wherein the at least one type of lost circulation material comprises a slurry.

10. The method according to claim 9, wherein the slurry comprises at least one of the group consisting of hydraulic cement, oil-bentonite-mud mixes, and high filter loss drilling fluids.

11. The method according to claim 1 wherein the method comprises adding pelletized coconut coir to the drilling fluid.

12. The method according to claim 1, wherein the method comprises using pellets of coconut coir sufficiently soft to be reduced into coconut coir particles before introduction into the borehole.

13. The method according to claim 1, wherein the method comprises using coconut coir pellets which have been compacted to minimize swelling of the coconut coir prior to release into the borehole.

14. The method according to claim 1, wherein the coconut coir is between 1 and 28 percent of the drilling fluid mixture by volume.

15. The method according to claim 2, wherein the coconut coir is between 1.4 and 14 percent of the drilling fluid mixture.

16. The method according to claim 1, wherein the borehole comprises an oil or gas well borehole.

17. A mixture for lubricating a drilling implement comprising:
a drilling fluid; and
coconut coir mixed with the drilling fluid.

18. The mixture of claim 17, wherein the mixture further comprises at least one type of lost circulation material other than coconut coir.

19. The mixture of claim 18, wherein the mixture comprises at least one of the group consisting of fibrous materials, flaky materials, granular materials, and slurries.

20. The mixture of claim 17, wherein the coconut coir comprises between about 0.5 percent 28 percent of the mixture by weight.

21. The mixture of claim 20, wherein the coconut coir comprises between about 1.4 and 14 percent by weight of the mixture.

22. A lost circulation material for use in preventing loss of drilling fluid in a borehole comprising coconut coir.

23. The lost circulation material according to claim 22, wherein the coconut coir comprises short fibers, flakes, granular pieces, and powder of coconut husk.

24. The lost circulation material according to claim 22, wherein the coconut coir is formed into pellets.

25. The lost circulation material according to claim 24, wherein the pellets are configured to be reduced to particles of coconut coir as they are being injected into the borehole.

26. The lost circulation material according to claim 24, wherein the pellets compacted sufficiently that they are not substantially reduced into particles of coconut coir before injection into the borehole.

27. The lost circulation material according to claim 26, wherein the pellets are compacted so that they slowly absorb fluid and swell.
